(19) United States
(12) Patent Application Publication
(10) Pub. No.: US 2008/0231545 A1
(43) Pub. Date: Sep. 25, 2008

(54) VIDEO PICTURE MANAGEMENT EQUIPMENT AND METHOD FOR VIDEO PICTURE MANAGEMENT

(75) Inventor: Yi Gong, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Tencent Technology (Shenzhen) Company Ltd., Shenzhen (CN)

(21) Appl. No.: 12/121,305

(22) Filed: May 15, 2008

Related U.S. Application Data
(63) Continuation of application No. PCT/CN2006/002742, filed on Oct. 17, 2006.

(30) Foreign Application Priority Data
Nov. 24, 2005 (CN) 200510123948.7

(51) Int. Cl. G09G 5/00

(52) U.S. Cl. 345/1.1

(57) ABSTRACT

A video picture management equipment includes a first display control module and a second display control module which are connected to each other. The first display control module displays first video data on first video window, and second video data on the first video window at the same time according to a requirement; and the second display control module displays the second video data on a second video window, and the first video data on the second video window at the same time according to a requirement. A method for video picture management is also provided. By the above, the problems about the simple display mode and the unstable display effect during performing the PIP in the prior art are solved.

### FIELD OF THE INVENTION

The present invention relates video communication technologies, and more particularly, to video picture management equipment and a method for video picture management.

### BACKGROUND OF THE INVENTION

During video chat, there are two video windows generally. One is a remote window, adapted to display remote video images, and the other is a local window, adapted to display local video images. The remote video data acquired from the network will be displayed on the remote window, while the video data acquired from the local video data acquiring equipment such as a camera will be displayed on the local window. As shown in FIG. 1, two different arrow directions represent a remote video image and a local video image respectively.

The Picture-In-Picture (PIP) video image mode used during the video chat refers to displaying video images of the two parties of the video chat on a video window; one is displayed as a main picture with the size of video window, and the other is displayed as a sub-picture with the designated size and covering the main picture. In this way, a user may see his video image and the remote video image simultaneously in the same video window. The PIP mode is shown in FIG. 2.

Conventionally, the PIP video image mode of the video chat is performed in a window overlapping way. More specifically, one video display window is reduced to a designated size and the size of the other window is not changed, and the reduced window overlaps the other window of which the size is not changed. At this point, the window with unchanged size is the main picture of the PIP mode and the reduced window is the sub-picture of the PIP mode. In this way, the picture-in-picture effect can be achieved in vision.

The PIP performed in the window overlapping way can only display a single PIP mode and has no more extensions such as the special effect of changing the shape of the sub-picture. Because windows are overlapped, there may be the case that windows of other programs overlap between the main picture and the sub-picture, thus affecting the display effect of the PIP and making the PIP display unstable. To perform the PIP mode, the window for displaying the sub-picture is reduced, which makes it impossible to see the video image content in the sub-picture with original size on this window.

### SUMMARY OF THE INVENTION

The present invention provides a video picture management equipment and method, so as to solve the problem about that the display mode is simple and the display effect is unstable during performing the PIP for the video chat in the prior art.

The technical scheme provided by the present invention is described below.

Video picture management equipment includes: a first display control module and a second display control module which are connected to each other; where

the first display control module is adapted to display first video data on first video window, and display second video data on the first video window at the same time according to a requirement; and

the second display control module is adapted to display the second video data on a second video window, and display the first video data on the second video window at the same time according to a requirement.

A method for video picture management includes:

acquiring first video data from a first video source, acquiring second video data from a second video source, and displaying the first video data and the second video data on one window;

where the first video data is displayed as a main picture and the second video data is displayed as a sub-picture.

By using the technical scheme of the present invention, the remote video data and the local video data are synchronously transmitted in the remote display control module and in the local display control module. By the synchronous processing of data, the remote video image and the local video image are synchronously displayed in the remote video window or in the local video window, realizing the display of various PIP modes. Two video images are displayed in the same video window by data processing, which avoids the harmful effects caused by the window overlapping; furthermore, the present invention may perform the special effect processing for the sub-picture, which avoids the affect to the main picture caused during the shape change or drift of the sub-picture.

### BRIEF DESCRIPTION OF THE DRAWINGS

FIG. 1 is a schematic diagram illustrating a common display mode of video chat picture, where two arrow directions indicate a remote picture and a local picture respectively.

FIG. 2 is a conventional schematic diagram illustrating a PIP display mode of a video chat, where two arrow directions indicate a remote picture and a local picture respectively.

FIG. 3 is a schematic diagram illustrating a PIP display mode for a video chat in accordance with an embodiment of the present invention, where two arrow directions indicate a remote picture and a local picture respectively, FIG. 3 including FIG. 3a˜FIG. 3e.

FIG. 4 is a schematic diagram of a structure of a video chat picture manager in accordance with an embodiment of the present invention.

FIG. 5 is a schematic diagram of a structure of a video picture control unit in accordance with an embodiment of the present invention.

FIG. 6 is a flowchart of non-PIP display.

FIG. 7 is a flowchart of displaying PIP on a remote video window.

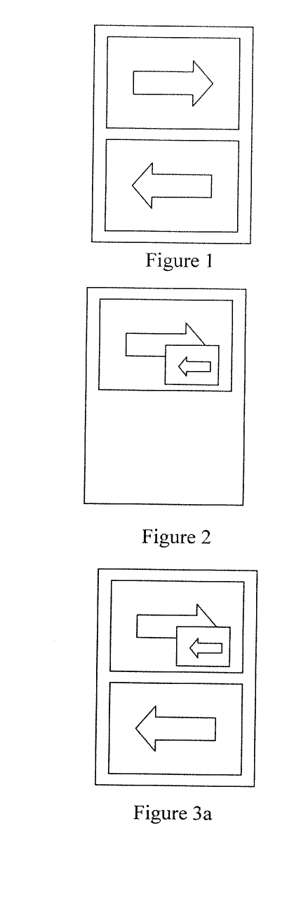

### DETAILED DESCRIPTION OF THE INVENTION

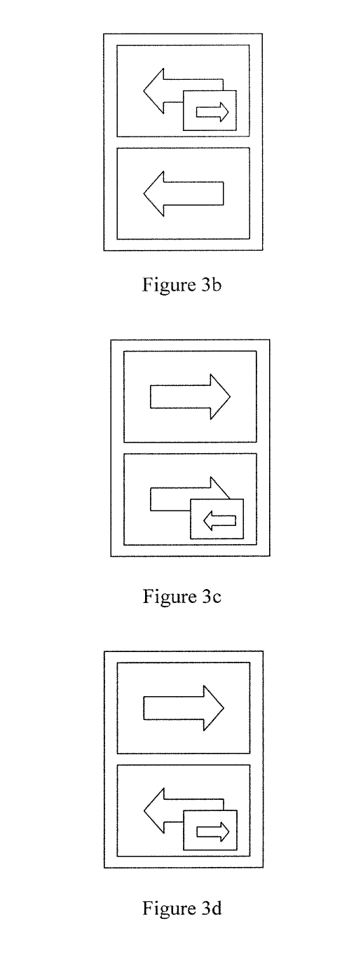

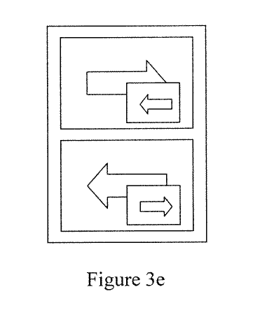

The present invention provides a video picture manager for performing various PIP modes, so as to control the exchange and display between the network video data and the local video data effectively in the PIP mode and perform various PIP display effects as shown in FIGS. 3a˜3e, thereby performing the PIP in more flexible mode and higher quality.

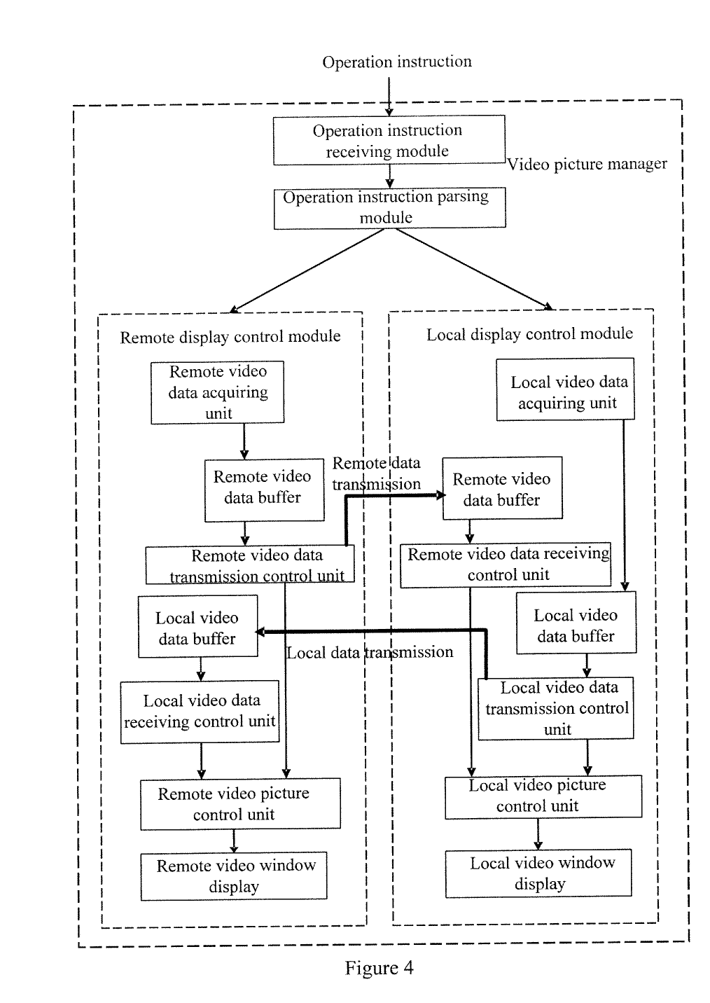

FIG. 4 is a schematic diagram of a structure of a video picture manager in accordance with an embodiment of the present invention. As shown in FIG. 4, the video picture manager for performing multiple PIP effects in accordance with the embodiment of the present invention includes two control modules: a remote display control module and a local display control module. The video picture manager further includes a user operation instruction receiving module and a user operation instruction parsing module. Upon receiving a user operation instruction, the user operation instruction receiving module sends the instruction to the user operation instruction parsing module. The user operation instruction parsing module parses the user operation instruction and sends a corresponding control instruction.

A remote video data acquiring unit acquires a remote video data frame from the network connected to the terminal and buffers the remote video data frame in a remote video data buffer, and indicates the remote video data transmission control unit to acquire the remote video data frame from the remote video data buffer and sends the video data frame to the remote video picture control unit. Similarly, a local video data acquiring unit acquires a video data frame from video data acquiring equipment connected to the terminal and buffers the video data frame in the local video data buffer, and indicates the local video data transmission control unit to acquire a video data frame from the buffer and sends the video data frame to the local video picture control unit.

The remote display control module and the local display control module respectively need to acquire the video data of each other simultaneously, which requires effective control of the video data transmission to perform various PIP modes. Because of the above:

Above all, the remote display control module and the local display control module respectively further include a corresponding data buffer zone and logic control. The remote display control module further includes a local video data buffer and a local video data receiving control unit. The local video data receiving control unit is adapted to control whether to receive the local video data; the remote video data transmission control unit further includes a data transmission control module to control whether to transmit the copied remote video data to the local display control module. In the remote video picture control unit, the remote video image from the remote video data transmission control unit and the local video image from the local video data receiving control unit are combined to be a PIP image displayed in the remote video window.

Similarly, the local display control module further includes a remote video data buffer and a remote video data receiving control unit. The remote video data receiving control unit is adapted to control whether to receive the remote video data. The local video data transmission control unit further includes a data transmission control module to control whether to transmit the copied local video data to the remote display control module. In the local video picture control unit, the remote video image from the remote video data receiving control unit and the local video image from the local video data transmission control unit are combined to be a PIP image displayed in the local video window. In this way, the data transmission can be performed through such logic control, and the PIP video image is realized.

Furthermore, a mode operation instruction is established in the operation instruction parsing module, and a corresponding relation between each logic control and the operation instruction is also established in the operation instruction parsing module, so as to perform the data control and the switch between different PIP modes according to the operation instruction. The operation instruction is the type of the PIP mode sent by a user to the system, such as non-PIP, PIP mode 1, PIP mode 2.

All logic controls are disabled if the non-PIP mode is used. In this way, there is no data transmission, and the local video window only displays a local video picture while the remote video window only displays a remote video picture. If a PIP mode is used and the PIP need be displayed in the remote window, the data reception of the remote display control module is enabled by the remote video data receiving control unit of the remote display control module, and the data transmission of the local display control module is enabled by the local video data transmission control unit of the local display control module. In other words, the data transmission from the local display control module to the remote display control module is enabled. In this way, the remote display control module can acquire the local video data from the local display control module and acquire the remote video data from the network, and therefore, the PIP mode is displayed in the remote video window under the control of the remote video picture control unit.

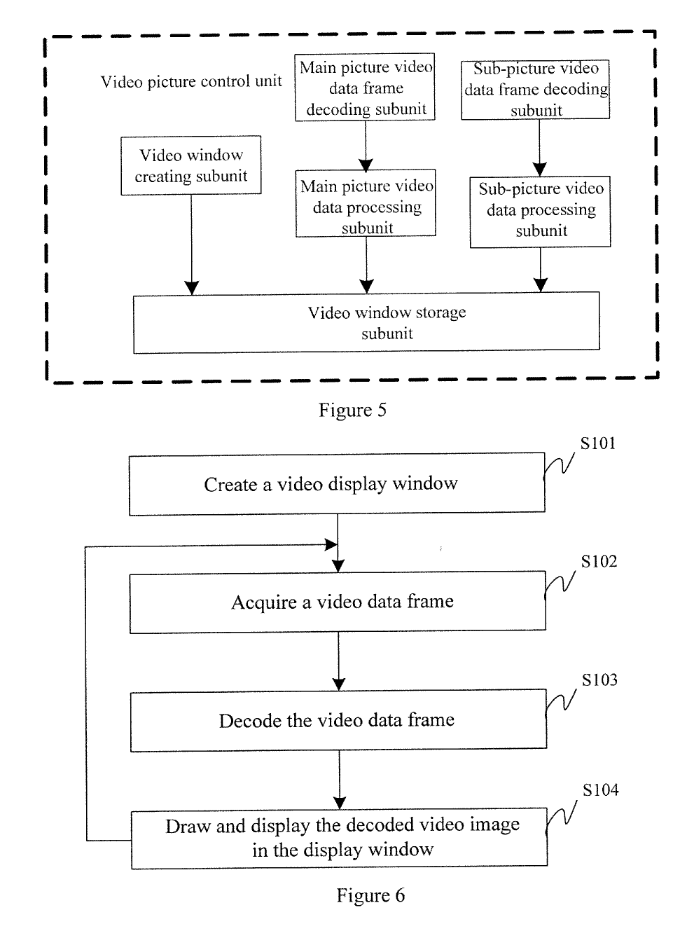

As shown in FIG. 5, the remote video picture control unit or the local video picture control unit includes: a video window creating subunit, a video window storage subunit, a video data decoding subunit and a video data processing subunit. There are two sets of video data decoding subunit and video data processing subunit configured in parallel, which are respectively adapted to the main picture display and the sub-picture display. The video window creating subunit is adapted to create a video display window while the video window storage subunit is adapted to store the video display window, main picture video data and sub-picture video data.

In the remote video window and the local video window, the location information of the main picture and the sub-picture is respectively set in the processing flow. If the special processing such as shape change or drift is needed by the sub-picture, sub-flow related to the shape change is preset in the processing flow.

The structure shown in FIG. 4 is a preferred embodiment of the present invention. In accordance with the technical scheme of the present invention, the PIP display control may be performed in only one of the remote video window and the local video window. On one hand, the types of mode instructions may be correspondingly reduced, on the other hand, the number of modules may be reduced. For example, if the PIP is displayed only in the remote video window, the remote video data buffer and the remote video data receiving control unit of the local display control module can be omitted.

As shown in FIGS. 3a˜3e, there are three modes for the selection of a PIP window, including displaying the PIP in the remote window, displaying the PIP in the local window or displaying the PIP in both the remote window and the local window. When the PIP mode is displayed, the remote party is selected as the main picture and the local party is selected as the sub-picture, or vice versa.

Besides the above for performing a PIP mode, a common display mode shown in FIG. 1 can also be performed.

The corresponding relations between instructions for various display modes may be shown in Table 1.

TABLE 1
corresponding relations between instructions for various display modes

| | Remote display control | | | Local display | | | |
|---|---|---|---|---|---|---|---|
| | module | | | control module | | | |
| Mode | | | Main | | | Main | |
| instruction | Output | Receive | picture | Output | Receive | picture | Note |
| Non-PIP | No | No | None | No | No | None | Common display (as |
| | | | | | | | shown in FIG. 1) |
| PIP mode 1 | No | Yes | Remote | Yes | No | None | The PIP is displayed in |
| | | | | | | | the remote window and |
| | | | | | | | the main window is the |
| | | | | | | | remote party (as shown |
| | | | | | | | in FIG. 3a) |
| PIP mode 2 | No | Yes | Local | Yes | No | None | The PIP is displayed in |
| | | | | | | | the remote window and |
| | | | | | | | the main window is the |
| | | | | | | | local party (as shown in |
| | | | | | | | FIG. 3b) |
| PIP mode 3 | Yes | No | None | No | Yes | Remote | The PIP is displayed in |
| | | | | | | | the local window and |
| | | | | | | | the main window is the |
| | | | | | | | remote party (as shown |
| | | | | | | | in FIG. 3c) |
| PIP mode 4 | Yes | No | None | No | Yes | Local | The PIP is displayed in |
| | | | | | | | the local window and |
| | | | | | | | the main window is the |
| | | | | | | | local party (as shown in |
| | | | | | | | FIG. 3d) |
| PIP mode 5 | Yes | Yes | Remote | Yes | Yes | Local | The PIP is displayed in |
| | | | | | | | both two windows (as |
| | | | | | | | shown in FIG. 3e) |

According to Table 1, the remote display control module can acquire the remote video data, the local video data is transmitted from the local display control module to the remote display control module, and the PIP can therefore be realized in the remote window. The local display control module can acquire the local video data, the remote video data is transmitted from the remote display control module to the local display control module, and the PIP can therefore be realized in the local window.

However, because the data flows relate to two threads of data reception and can not be performed by a simple control, it is required to create a mode instruction. The operation instruction parsing module of a user parses a user instruction and delivers a logic control command to related function units of the two control modules respectively at the same time according to a mode set by the user, so that the data transmission and processing is implemented.

In the above video picture manager, the remote video picture control module of the main picture and the local video picture control module of the main picture respectively decode a remote video data frame and a local video data frame upon simultaneously acquiring the remote video data frame and the local video data frame. According to preset flow, one of the remote video data frame and the local video data frame is displayed as a main picture, and the other is displayed as a sub-picture. The sub-picture is directly drawn at the set location of the video window of the main picture and displayed in synchronization with the main picture. The default display is configured as the non-PIP display if a user initiates a video picture manager. At this point, the control flow of the remote video picture control module of the main picture or the local video picture control module of the main picture is shown in FIG. 6. The process for initiating the main picture video data decoding subunit and the main picture video data processing subunit to process, frame by frame, the video data includes:

S101: Create a video display window at the set location of the display memory;

S102: Receive a video data frame sent by a data receiving control module;

S103: Decode the video data frame;

S104: Draw and display the decoded data in the video display window according to the set amplification multiple;

S105: Return to S102.

The S101 to S105 are executed circularly. The whole main picture is displayed in the video window by the cooperation of the video window creating subunit, the main picture video data frame decoding subunit and the main picture video data processing subunit.

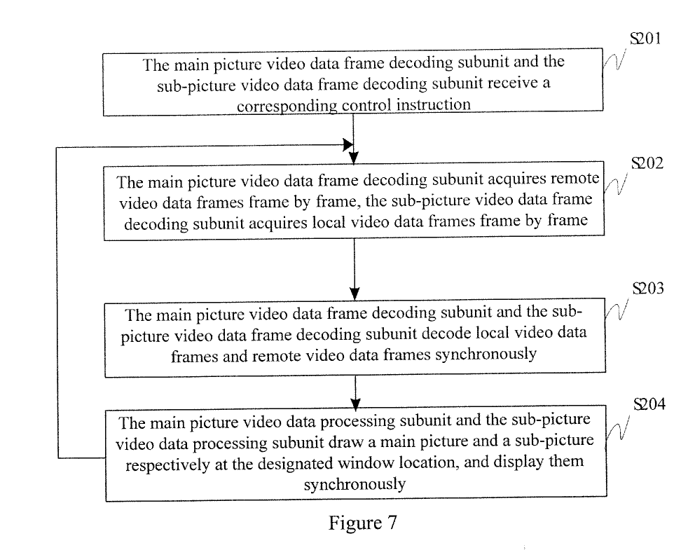

The remote video picture control module of the main picture or the local video picture control module of the main picture controls the display of a PIP mode upon receiving a switch instruction of display modes from a user. Supposing that the type of the control instruction is to display a remote video in the main picture of the remote video window and display a local video in the sub-picture of the remote video window, as shown in FIG. 7, the control flow includes the following:

S201: The main picture video data frame decoding subunit and the sub-picture video data frame decoding subunit receive a corresponding control instruction;

S202: The main picture video data frame decoding subunit acquires remote video data frames frame by frame; the sub-picture video data frame decoding subunit acquires local video data frames frame by frame;

S203: The main picture video data frame decoding subunit and the sub-picture video data frame decoding subunit synchronously decode local video data frames and remote video data frames;

S204: The main picture video data processing subunit and the sub-picture video data processing subunit draw a main picture and a sub-picture respectively at the designated locations of the video window, and display them synchronously; and the process returns to S202.

The size and location information of the main picture video window, the location information of the sub-picture and the control flow for performing such special effect control as shape change or drift are preset in the processing flow. Because the main picture and the sub-picture are displayed in the same video window synchronously, special effects such as shape change or drift of the sub-picture do not affect the display effect of the main picture.

If the processing flow of the shape change of the sub-picture is preset, the flow is initiated in S204 to perform the corresponding processing for the video data of the sub-picture. The synchronous display technology of the main picture and the sub-picture as well as the shape change processing technology of the sub-picture in S204 may be performed by the DirectX video image processing technology or other video image processing technologies, which is well known by those skilled in the art and will not be described herein.

When receiving an instruction of switching to the non-PIP mode from a user, the process returns to S102 to perform circular control.

The forgoing is only described by taking one PIP display processing flow, and the processing flows of other PIP modes are the same as the forgoing, which will not be described herein.

The foregoing are only preferred embodiments of the present invention and are not for use in limiting the protection scope thereof. Any modification, equivalent replacement and improvement made under the present invention should be included in the protection scope of the present invention.

What is claimed is:

1. Video picture management equipment, comprising: a first display control module and a second display control module which are connected to each other; wherein
the first display control module is adapted to display first video data on first video window, and display second video data on the first video window at the same time according to a requirement; and
the second display control module is adapted to display the second video data on a second video window, and display the first video data on the second video window at the same time according to a requirement.

2. The equipment of claim 1, wherein the first display control module comprises:
a video data acquiring unit adapted to acquire the first video data from a video source;
a first video data buffer adapted to buffer the first video data from the video source;
a video data transmission control unit, connected to the first video data buffer and the second display control unit, adapted to control data transmission of the first video data buffer;
a video picture control unit connected to the video data transmission control unit, adapted to display the first video data in the first video window.

3. The equipment of claim 2, wherein the first display control module further comprises:
a second video data buffer connected to the second display control module, adapted to acquire the second video data from the second display control module and buffer the second video data; and
a video data receiving control unit connected to the second video data buffer and the video picture control unit, adapted to control data reception of the second video data buffer; wherein
the video picture control unit is further adapted to display the first video data and the second video data in the first video window.

4. The equipment of claim 3, further comprising:
an operation instruction receiving module, adapted to receive an operation instruction; and
an operation instruction parsing module, adapted to parse the operation instruction and send a control signal to the first display control module or the second display control module according to a parsing result;
wherein
the video data transmission control unit is adapted to control whether to send the first video data to the second display control module according to the control signal; and
the video data receiving control unit is adapted to control whether to receive the second video data from the second display control module according to the control signal.

5. The equipment of claim 2, wherein the video picture control unit comprises:
a video window creating subunit, adapted to create a video display window;
a first-picture video data frame decoding subunit, adapted to acquire the first video data; and a first-picture video data processing subunit, adapted to process the first video data and send the first video data to a video window storage subunit in the video picture control unit, wherein the first-picture video data frame decoding subunit connects to the video data transmission control unit;
a second-picture video data frame decoding subunit, adapted to acquire and process the second video data; and a second-picture video data processing subunit, adapted to send the second video data to the video window storage subunit, wherein the second-picture video data frame decoding subunit connects to the video data receiving control unit; and
the video window storage subunit, adapted to store the video display window, the first video data and the second video data.

6. The equipment of claim 3, wherein the video picture control unit comprises:
a video window creating subunit, adapted to create a video display window;
a first-picture video data frame decoding subunit, adapted to acquire the first video data; and a first-picture video data processing subunit, adapted to process the first video data and send the first video data to a video window storage subunit in the video picture control unit, wherein the first-picture video data frame decoding subunit connects to the video data transmission control unit;
a second-picture video data frame decoding subunit, adapted to acquire and process the second video data; and a second-picture video data processing subunit, adapted to send the second video data to the video window storage subunit, wherein the second-picture video data frame decoding subunit connects to the video data receiving control unit; and
the video window storage subunit, adapted to store the video display window, the first video data and the second video data.

7. The equipment of claim 4, wherein the video picture control unit comprises:
a video window creating subunit, adapted to create a video display window;
a first-picture video data frame decoding subunit, adapted to acquire the first video data; and
a first-picture video data processing subunit, adapted to process the first video data and send the first video data to a video window storage subunit in the video picture control unit, wherein the first-picture video data frame decoding subunit connects to the video data transmission control unit;
a second-picture video data frame decoding subunit, adapted to acquire and process the second video data; and a second-picture video data processing subunit, adapted to send the second video data to the video window storage subunit, wherein the second-picture video data frame decoding subunit connects to the video data receiving control unit; and
the video window storage subunit, adapted to store the video display window, the first video data and the second video data.

8. The equipment of claim 2, wherein the video source is a network or video data acquiring equipment.

9. A method for video picture management, comprising:
acquiring first video data from a first video source,
acquiring second video data from a second video source, and
displaying the first video data and the second video data on one window;
wherein the first video data is displayed as a main picture and the second video data is displayed as a sub-picture.

10. The method of claim 9, further comprising:
acquiring an operation instruction,
parsing the operation instruction, and
determining a mode for displaying the first video data and the second video data on said one window according to the operation instruction.

11. The method of claim 9, wherein displaying the first video data and the second video data on one window comprises:
decoding a first video data frame corresponding to the first video data and a second video data frame corresponding to the second video data simultaneously; and
drawing and displaying a first video image and a second video image respectively at a main picture location and a sub-picture location which are preset in said one window.

12. The method of claim 11, further comprising:
controlling display of the sub-picture according to information of shape change and/or location change of the sub-picture.
